(19) United States
(12) Patent Application Publication
(10) Pub. No.: US 2022/0355212 A1
(43) Pub. Date: Nov. 10, 2022

(54) LIVESTREAM VIDEO IDENTIFICATION

(71) Applicant: Microsoft Technology Licensing, LLC, Redmond, WA (US)

(72) Inventors: Brandon James LOUDEN, Everett, WA (US); Mansi VERMA, Kirkland, WA (US); Abebe Tadesse BIRU, Issaquah, WA (US); Donald Frank BRINKMAN, JR., Seattle, WA (US)

(21) Appl. No.: 17/316,636

(22) Filed: May 10, 2021

(51) Int. Cl. A63F 13/86; G06K 9/00; H04N 21/2187; H04N 21/84; H04N 21/478; H04N 21/482; H04N 21/4788; H04N 21/234; G10L 15/22; G10L 15/26; G10L 25/57; G06F 16/738

(52) U.S. Cl. CPC A63F 13/86; G06K 9/00718; G06K 9/00228; H04N 21/2187; H04N 21/84; H04N 21/4781; H04N 21/4826; H04N 21/4788; H04N 21/23418; G10L 15/22; G10L 15/26; G10L 25/57; G06F 16/738; G06K 2009/00738; G06F 3/04847

(57) ABSTRACT

A computing system is described herein, where the computing system is configured to perform a search over a computer-readable index based upon a query for a user. The computer-readable index includes an identifier for a livestream video that is currently being livestreamed by way of a livestreaming service and values for respective attributes of the livestream video. The values for the respective attributes are updated as content of the livestream video alters over time. The livestream video is identified from amongst several livestream videos based upon the search, where the video is identified due to a set of values specified in the query corresponding to the values for the respective attributes in the computer-readable index. Upon the livestream video being identified, an identifier of the livestream video is transmitted to a client computing device of the user.

### BACKGROUND

Popularity of electronic sports (“esports”) has vastly increased over a relatively short period of time due at least partially to proliferation of livestreaming services. Esports is a form of competition where multiple video game players compete against one another when playing a video game. Players livestream their gameplay by way of a livestreaming service, where multiple viewers can watch a livestream of a player who is streaming his or her gameplay. Livestreaming refers to online streaming media that is simultaneously recorded and broadcast in real-time, which is different from other types of streaming media, such as video on demand, as the other types of streaming media are streamed to client computing devices from a streaming service but are not “live”.

As popularity of esports and livestreaming has increased, a number of livestreams available for viewing has likewise increased. For example, at any one instance in time, there may be hundreds of thousands of livestreams that are available for viewing by a user of a livestreaming service. While esports has been given as an example, conventional livestreaming services host many different types of livestreaming content, including live virtual blogs, live music channels where a virtual DJ is presenting and commenting on music, etc.

Conventionally, for a user of the livestreaming service to identify a livestream that may be of interest to the user, the user can formulate a query and submit the query to the livestreaming service. The livestreaming service indexes livestreams by identities of streamers of the livestreams and metadata assigned to the livestreams by the streamers. For example, a streamer who is streaming play of a video game can identify the video game being played by the streamer and can assign tags to the livestream such as “family friendly”, “top player”, etc. The livestreaming service additionally tracks a number of viewers of the streamer over time, and therefore the livestreaming service can identify most popular streamers. When the user of the livestreaming service wishes to locate a livestream of a particular video game, the user can set forth a query that includes an identity of the video game. The livestreaming service returns a ranked list of livestreams where the streamer has manually indicated they are playing the particular video game (and where the livestreams are ranked, for example, by popularity of the streamers).

From the foregoing, it can be ascertained that conventional livestreaming services render it difficult for a user to identify a livestream that includes content that is of interest to the user. For a single video game, there may be thousands of livestreams of such video game being simultaneously streamed by the livestreaming service. When the user is interested in a particular level of the video game, for example, the livestreaming service forces the user to manually sift through numerous livestreams before the user is able to identify a livestream that depicts the level of the video game that is of interest to the user. This results in unduly utilizing network resources, as the user may initiate viewing of several different livestreams before identifying a livestream that is of interest to the user.

### SUMMARY

The following is a brief summary of subject matter that is described in greater detail herein. This summary is not intended to be limiting as to the scope of the claims.

Described herein are technologies that enable a user to identify a livestream video from amongst numerous livestream videos based upon content of the livestream video. A livestreaming service simultaneously streams multiple livestream videos to client computing devices of multiple viewers. Pursuant to an example, a livestream video is analyzed in real-time (as the video is being livestreamed to the livestreaming service by a streamer), and values for respective attributes of the livestream video are computed. The values for the attributes are indicative of content of the livestream video. Pursuant to an example, an attribute may be a character of a video game, wherein the streamer is playing the video game with the character. The value for the attribute identifies the character of the video game being played by the streamer. In another example, an attribute may be a level of a video game being played by a streamer. Hence, the value of the attribute identifies the level of the video game currently depicted in the livestream video.

Values for the attributes may be updated as content of the livestream video changes. Further, a computer-readable index is updated to include the values for the attributes, where the computer-readable index indexes livestream videos by values of the attributes for the livestream videos, and further where the computer-readable index is updated as the values for the attributes change. Accordingly, when a user submits a query that specifies a character of interest to the user, an identity of a livestream video of a video game being played by a streamer is returned, where the streamer is playing the video game as the character specified in the query. It is understood that content of the computer-readable index is updated as content of livestream videos changes over time. Therefore, when the user submits a query, the user is provided with identities of one or more livestream videos that are germane to the query, and therefore are of interest to the user.

For example, a user may want to search for livestream videos where streamers of such videos are currently playing as a particular character in a game that has multiple character options, such as Super Smash Bros. Ultimate. In another example, a user may want to search for livestream videos where streamers of such videos are currently using a sniper rifle in a battle royale style game, such as Fortnite. As another example, a user may want to search for livestream videos where streamers of such videos have high engagement with their viewers during the livestream videos. As a further example, a user may want to search for a livestream video where a streamer playing a video game depicted in the livestream video has particular equipment or a particular skill build in a roleplaying game, such as League of Legends. As yet a further example, a user may want to search for a livestream video that has a combination of the above-referenced attributes. In accordance some embodiments, the technologies described herein analyze the livestreams to identify games and game attributes so as to be able to respond to user queries directed to specific games and attributes, e.g., without having to rely on the streamers to manually update their stream tags or descriptions.

In another embodiment, livestream videos are recommended to a user based upon livestream videos previously viewed by the user. More specifically, a profile for the user is constructed over time based upon livestream videos viewed by the user, amounts of time that the user viewed the livestream videos, and values of attributes of the livestream videos. For instance, the profile for the user may indicate that the user prefers to watch livestream videos of streamers who are humorous (rather than serious). Therefore, a livestream video may be recommended to the user due to the livestream video being assigned a value in the computer-readable index that indicates that the streamer of the livestream video is humorous.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 depicts an example graphical user interface that is configured to provide a ranked list of livestream videos to a user.

FIG. 2 is a functional block diagram of an example computing system that is configured to return a ranked list of livestream videos to a client computing device based upon values of attributes computed for the livestream videos.

FIG. 3 illustrates an example livestream video and accompanying chat text.

FIG. 4 is a functional block diagram of an example computer-executable module that is configured to compute values for attributes of livestream videos as the livestream videos are being streamed.

FIG. 5 is a functional block diagram of an example computer-executable module that is configured to identify and rank livestream videos based upon computed values for attributes of the livestream videos.

FIG. 6 illustrates an example computer-readable index of livestream videos.

FIG. 7 is a flow diagram that depicts an example methodology for providing a ranked list of livestream videos to a client computing device of a user.

FIG. 8 is a flow diagram that depicts an example methodology for recommending a livestream video to a user based upon values computed for attributes of the livestream video.

FIG. 9 depicts an example computing system.

### DETAILED DESCRIPTION

Various technologies pertaining to identifying livestream videos based upon real-time attribute values computed for the livestream videos are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Described herein are technologies that enable a user to relatively easily identify livestream videos that are of interest to the user, where the livestream videos are identified based upon content of the livestream videos. With more specificity, a livestream video being streamed by a streamer by way of a streaming service is analyzed, and values for attributes of the livestream video are computed based upon content of the livestream video. For example, the livestream video is a stream of a video game being played by the streamer, and an attribute of the livestream video is a character being used by the streamer when playing the video game. The user can set forth a query that includes the value for the attribute (e.g., “Mario”), and the livestream video can be returned to the user due to the streamer playing the video game while using the character specified in the query. These technologies are in contrast to conventional technologies for identifying livestream videos for a user, where values for attributes of a livestream video are limited to metadata tags assigned to the livestream video by the streamer, which may not be germane to actual content of the livestream video.

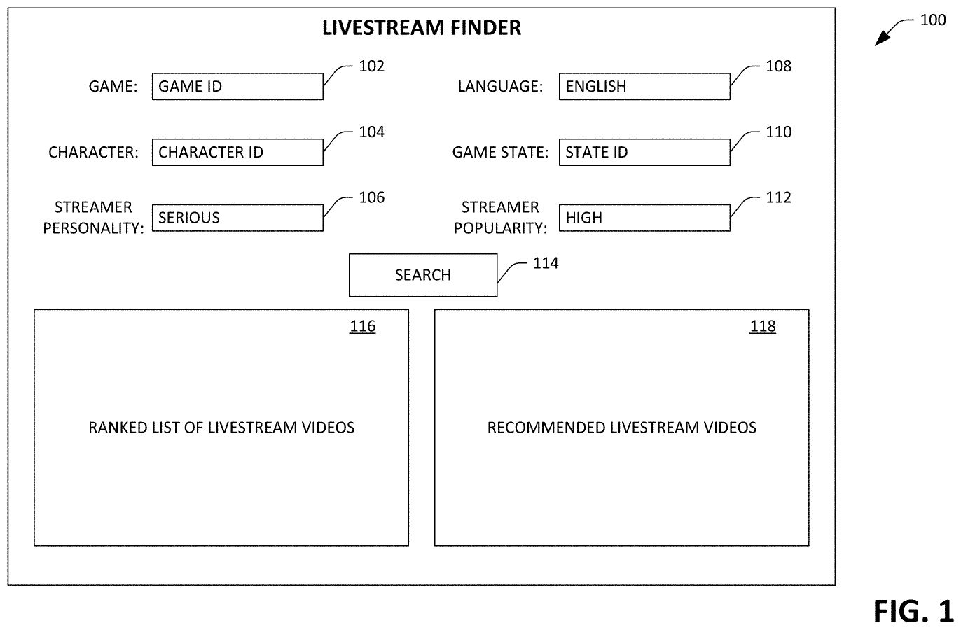

Referring now to FIG. 1, a graphical user interface (GUI) 100 is illustrated, wherein the GUI 100 is configured to receive input from a user searching for a livestream video and is further configured to display livestream videos that are identified based upon the input set forth by the user. As noted above, a livestream video is a video that is simultaneously recorded and broadcast in real-time. Livestream videos can be distinguished from other videos that are referred to as “streaming” videos, as streaming videos are recorded at a first point in time and broadcast at a second point in time that is later than the first point in time. The technologies described herein are particularly advantageous with respect to livestream videos that are streamed by streamers who are playing a video game (such as a video game being played in an esports tournament). The technologies described herein, however, are not limited to livestream videos streamed by streamers who are playing video games. For example, the technologies described herein can be employed in connection with identifying broadcast media that may be of interest to a user, streamed video blogs, and other “live” video.

The GUI 100 includes fields 102-112, where the fields are configured to receive user-specified values for respective attributes of livestream videos being streamed by way of a livestreaming service or an aggregation of livestreaming services, wherein the user is attempting to locate livestream videos with the user-specified values. While several example attributes are described with respect to the fields 102-112, it is to be understood that, in a given embodiment, a GUI may include a subset of such fields and/or may include other fields that are configured to receive values for other attributes, such as current character equipment, character skill build, whether a streamer is playing a video game in a group or solo, etc. As illustrated in FIG. 1, the GUI 100 is configured to receive values for attributes of livestream videos being streamed by streamers who are playing video games. Thus, the first field 102 is configured to receive a name of a video game that is of interest to the user. The second field 104 is configured to receive an identity of a character that is of interest to the user, where the character is included in the video game identified in the first field 102. The third field 106 is configured to receive a personality type that is of interest to the user, where the user is searching for a livestream that is streamed by a streamer who has the personality type specified in the third field 106. The fourth field 108 is configured to receive an identity of a language, where the user is interested in locating a livestream video that is being streamed in the language identified in the fourth field 108. The fifth field 110 is configured to receive a video game state that is of interest to the user, where the video game state may be a level of a video game, a scene of a video game, a status of an esports tournament or a match in an esports tournament (e.g., the user may desire to watch a livestream being streamed by a current leader of a match in an esports tournament rather than a livestream being streamed by another participant in the esports tournament), etc. The sixth field 112 is configured to receive a value that identifies a popularity level that is of interest to the user, such that the user is interested in receiving a livestream video being streamed by a streamer who is at the popularity level specified in the sixth field 112. For instance, the user is interested in identifying a relatively unknown streamer, and therefore specifies a popularity level of “low”.

The GUI 100 further includes a selectable button 114, whereupon the button 114 being selected, a query is transmitted from a client computing device that displays the GUI 100 to a server computing system (not shown), where the server computing system searches a computer-readable index based upon the query, identifies livestream videos based upon the search, ranks the identified livestream videos, and returns a ranked list of livestream videos to the client computing device. The GUI 100, upon receiving the ranked list of livestream videos, is updated to depict the ranked list of livestream videos in a field 116 of the GUI 100.

The query may be a Boolean query, such that in accordance with the user-input attribute values illustrated in FIG. 1, the query is “GAME ID” AND “CHARCTER ID” AND “SERIOUS” AND “ENGLISH” AND “STATE ID” AND “LOW”. As will be described in greater detail below, the server computing system searches the computer-readable index for livestream videos that have the values for the attributes specified in the query (and/or livestream videos that have similar values for the attributes specified in the query). While a Boolean query is given as an example, it is to be understood that the computer-readable index can be searched based upon semantic analysis of queries, through use of regular expressions, etc. Livestream videos streamed by way of a streaming service (or multiple livestreaming services) are analyzed in real-time, and values for attributes of the livestream videos are computed and updated as content of the livestream videos alters over time. Therefore, the computer-readable index includes computed values for attributes that reflect current content of the livestream videos that are indexed by such index. The livestream videos included in the ranked list of livestream videos depicted in the field 116 are ranked based upon weights assigned to attributes of the livestream videos. Any suitable ranking technologies can be employed when ranking livestream videos that are identified based upon the search of the computer-readable index.

It can therefore be ascertained that, through utilization of the technologies described herein, the user is provided with livestream videos that have attribute values that are of interest to the user, such that the user is provided with livestream videos (streamed by way of a streaming service) that are of interest to the user. While the GUI 100 is illustrated as including fields by way of which the user can specify values for attributes, other approaches are contemplated. For instance, a natural language query may be set forth by the user, and the server computing system can parse the natural language query and search the computer-readable index based upon the parsing of the natural language query. Further, while the GUI 100 depicts a few example attributes whose values can be specified by the user, it is to be understood that additional attributes are contemplated, such as ratings of livestream videos (e.g., where a rating is indicative of a recommended age of a viewer of a livestream video), an event that has recently occurred in a livestream video (e.g., a “boss” in a video game has been defeated, a weapon in a video game deployed, a lead has changed in a racing video game, a score has changed in a football video game, a high score is being approached in a video game, etc.). Therefore, in summary, the user can set forth a relatively granular query when searching for livestream videos and is provided with identities of livestream videos that correspond to the query, such that the user is provided with livestream videos that match the specified interests of the user.

The GUI 100 optionally includes a field 118 that is configured to depict livestream videos that are recommended to the user based upon historic interactions of the user with livestream videos. For instance, a profile of the user may be constructed and updated over time, where the profile includes values of attributes that are learned to be of interest to the user. The user may set forth a high rating to a livestream video and/or a streamer of the livestream video (e.g., the user may set forth a 5-star rating, may follow or subscribe to the streamer, may indicate that the user “likes” the livestream video and/or streamer, etc.). In addition, the user may spend a relatively large amount of time watching a set of livestream videos. These interactions of the user with livestream videos are monitored, and the above-mentioned computer-readable index can be analyzed to identify values for attributes of the livestream videos that the user was watching, had rated highly, had rated lowly, etc. The profile of the user can be updated to reflect that the user is interested in livestream videos having the same or similar attribute values as the livestream videos previously watched by the user for relatively long times and/or rated highly by the user. Similarly, the profile of the user can be updated to reflect that the user is not interested in livestream videos having the same or similar attributes values as livestream videos previously watched by the user for short amounts of time and/or rated lowly by the user. Based upon values of attributes specified in the user profile, the computer-readable index is searched and livestream videos that correspond to the user profile are identified and presented in the field 118. Thus, the query employed to search the computer-readable index of livestream videos may be explicitly provided by the user or implicitly constructed based upon the profile of the user.

As indicated previously, the approaches discussed herein exhibit various advantages over conventional approaches for identifying livestream videos that may be of interest to a user. Conventionally, streamers assign metadata tags to videos being streamed by the streamers. In some cases, the metadata tags are assigned by the streamers to increase the number of viewers of the livestream video of the streamer, but do not accurately reflect content of the livestream video. For instance, the streamer may assign a tag to a livestream video with respect to a video game that indicates that the streamer is an expert in the video game; however, in reality, the streamer may be merely adequate. Further, there is currently no suitable approach for identifying a livestream video based upon current content of the livestream video, as streaming services do not analyze content of livestream videos as the videos are being streamed. The technologies described herein relate to constructing a computer-readable index of livestream videos that is updated as content of the livestream videos change over time. Accordingly, the livestream videos are indexed by values that are reflective of current, actual content of the livestream videos.

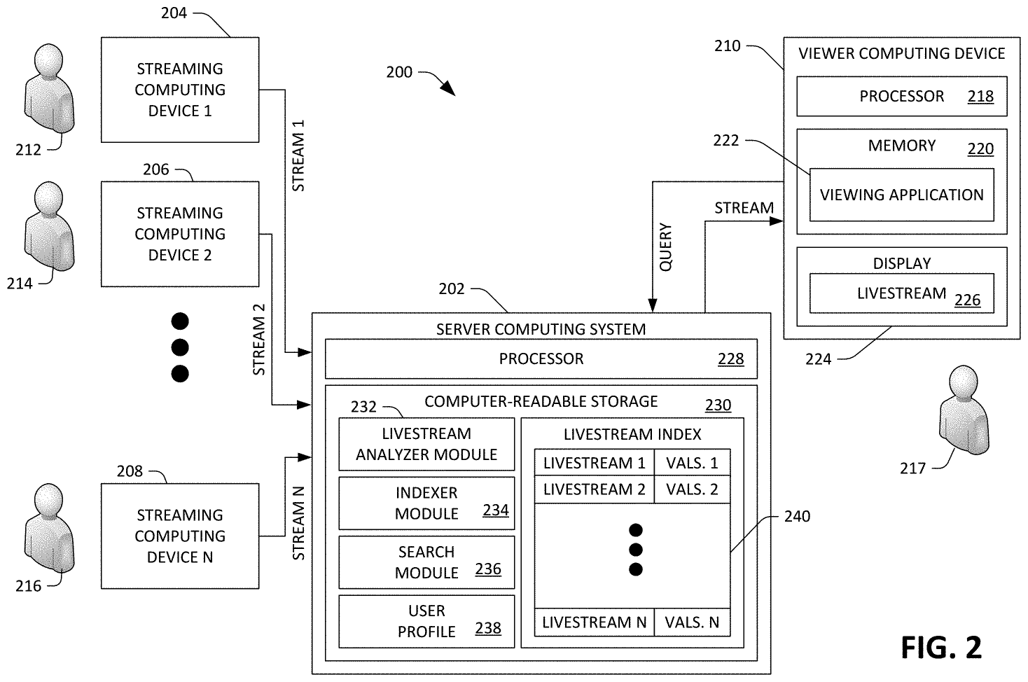

Referring now to FIG. 2, a functional block diagram of a computing system 200 that is configured to receive a query and return an identifier of a livestream video based upon the query is illustrated. The computing system 200 includes a server computing system 202, several streaming computing devices 204-208 that are in network communication with the server computing system 202, and a viewer computing device 210 that is in network communication with the server computing system 202. The streaming computing devices 204-208 are operated by respective streamers 212-216. While not illustrated, the streaming computing devices 204-208 may have respective cameras associated therewith that capture video of faces of the streamers 212-216 (e.g., while the streamers 204-208 are playing a video game that is being livestreamed). In addition, the streaming computing devices 204-208 may have respective microphones associated therewith, such that spoken utterances of the streamers 212-216 is captured. The streaming computing devices 204-208 construct livestream videos and transmit the livestream videos to the server computing system 202. As illustrated, the first streaming computing device 204 constructs and transmits a first livestream video to the server computing system 202, the second streaming computing device 206 constructs and transmits a second livestream video to the server computing system 202, and the Nth streaming computing device 208 constructs and transmits an Nth livestream video to the server computing system 202. The server computing system 202 receives the livestream videos from the streaming computing devices 204-208 and streams the livestream videos to viewer computing devices that have requested to view the livestream videos. For example, the first livestream video is transmitted from the server computing system 202 to a viewer computing device (such as the viewer computing device 210), where the first livestream video is presented on a display of the viewer computing device.

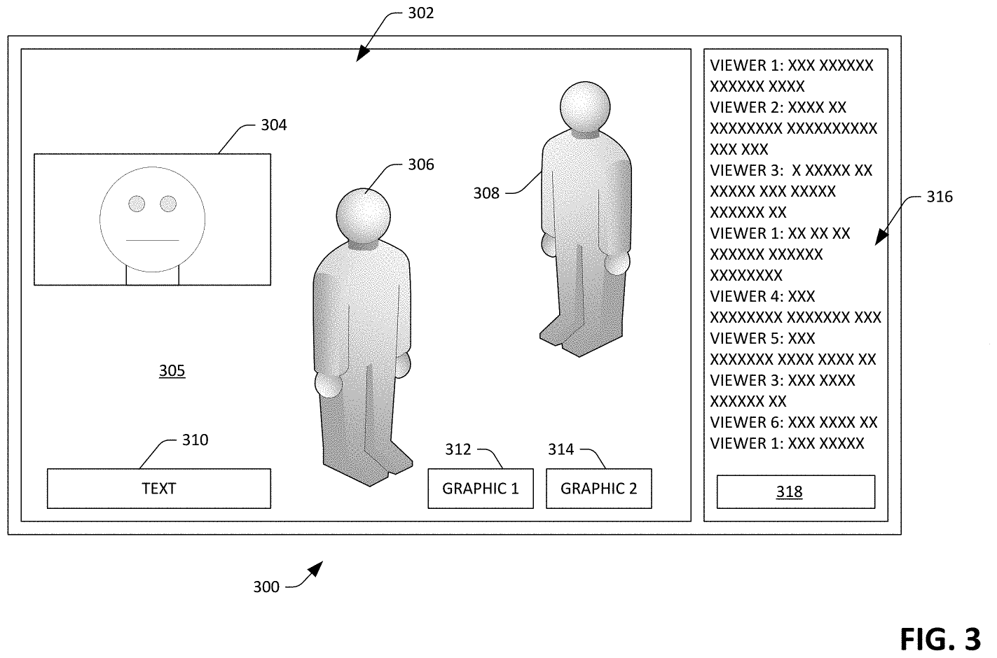

Turning to FIG. 3, a GUI 300 that includes a livestream video 302 that is viewable on a viewer computing device is illustrated. The livestream video 302 includes a video portion 304 that includes video of the face of the streamer of the livestream video 302. In the example depicted in FIG. 3, the livestream video 302 also includes a gaming portion 305 that depicts real-time video of a video game being played by the streamer. The gaming portion 305 depicts characters 306 and 308 in the video game. For instance, the streamer is playing as the first character 306, and the second character 308 is controlled by another participant in the video game. The gaming portion 305 may include text 310 that is included in the video game and graphics 312 and 314 that are included in the video game. The text 310 can describe status of the video game, may be a transcription of speech of one or both of the characters 306 or 308, etc., and the graphics 312 and 314 may be indicative of status of the video game, accessories available for the first character 306, a bar showing remaining life of the first character 306, and so forth. It is therefore to be understood that the text 310 and graphics 312 and 314 are set forth to represent any suitable text and graphics that may be included in video games.

The GUI 300 also includes a chat window 316 that displays messages set forth in a chat by multiple viewers of the livestream video 302. As illustrated, six different viewers of the livestream video 302 are setting forth messages to one another, where the messages are viewable to all viewers of the livestream video 302. The chat window 316 includes a text entry field 318, where the viewer of the livestream video 302 may set forth text in the text entry field 318 and participate in the chat. The server computing system 202 is configured to receive the chat messages from viewers of the livestream video 302 and place such chat messages in the chat window 316 as such chat messages are received. The server computing system 202 is also configured to include the chat window 316 in the GUI 300, such that viewers of the livestream video 302 are able to review chat messages and participate in the chat.

Returning to FIG. 2, the viewer computing device 210 is operated by a user 217, where the user 217 employs the viewer computing device 210 to retrieve and view a livestream video (streamed by the server computing system 202) that is of interest to the user 217. The viewer computing device 210 includes a processor 218 and memory 220, where the memory 220 includes a viewing application 222 that is configured to receive and present a livestream video to the user 217. The viewing application 222 may be a browser or a dedicated application for viewing livestream videos streamed by the server computing system 202.

The viewer computing device 210 also includes a display 224 that is operably coupled to the processor 218. The display 224 displays a livestream video 226 that is output for display by the viewing application 222. As will be described in greater detail below, the viewing application 222 can be employed by the user 217 to transmit a query to the server computing system 202, and the server computing system 202 can return an identifier for a livestream video to the viewer computing device 210 based upon the query.

As described previously, the server computing system 202 receives livestream videos from the streaming computing devices 204-208 and streams one or more of the livestream videos to viewer computing devices that request the livestream videos. The server computing system 202 includes a processor 228 and computer-readable storage 230 that is operatively coupled to the processor 228. The computer-readable storage 230 may be memory, solid state storage, a hard drive, etc.

The computer readable storage 230 includes a livestream analyzer module 232, an indexer module 234, and a search module 238 that are executed by the processor 228. The computer readable storage 230 also includes a viewer profile 238 and a livestream index 240, where the livestream index 240 indexes livestream videos by values for attributes of the livestream videos.

The livestream analyzer module 232 receives the livestream videos transmitted to the server computing system 202 by the streaming computing devices 204-208. The livestream analyzer module 232 also receives chat messages that respectively accompany the livestream videos. The livestream analyzer module 232 is configured to compute values for attributes of the livestream videos based upon content of the livestream videos as well as text in chats that respectively accompany the livestream videos. Example attributes of a livestream video for which the livestream analyzer module 232 can compute values include, but are not limited to, rating of the livestream video (where the rating is indicative of a recommended age range of viewers of the livestream video), a character being used by a streamer of the livestream video when playing a video game depicted in the livestream video, a character not being used by the streamer that is in the same scene as the character being used by the streamer, a state of the video game (e.g., a level of the video game, an identity of a “boss” being battled in the video game, etc.), a scene in the video game that is currently displayed in the livestream video, an event that has occurred in the video game (e.g., the defeat of a boss, the passing of a level, approaching or surpassing a high score, etc.), sentiment of the livestream video (e.g., “humorous”, “serious”, “sad”, “angry”, etc.), and so forth. The livestream analyzer module 232 can compute the values for the attributes based upon content of the livestream videos and can update the values for the attributes for the livestream videos as content of the livestream videos changes (and/or as content of chats that accompany the livestream videos changes). Operation of the livestream analyzer module 232 will be described in greater detail below.

The indexer module 234 is configured to receive the values computed by the livestream analyzer module 232 for the livestream videos streamed to the server computing system 202 by the streaming computing devices 204-208, and is further configured to update the livestream index 240 with the computed values upon receiving the computed values from the livestream analyzer module 232. Thus, in an example, the livestream analyzer module 232 receives the first livestream video streamed to the server computing system 202 by the first streaming computing device 204. In the first livestream video, the streamer 212 is playing a video game as a character within a level of the video game. The livestream analyzer module 232 can output values for the first livestream video that identify the video game, the character, and the level. The indexer module 234 receives these computed values and updates the livestream index 240 to include the values for the first livestream video. That is, the first livestream video is indexed in the livestream index 240 by the values for the attributes of the first livestream video computed by the livestream analyzer module 232. As discussed above, the livestream analyzer module 232 can be configured to compute values for attributes of numerous livestream videos received by the server computing system 202, and thus the livestream index 240 includes identities of multiple different livestream videos and computed values for attributes of the livestream videos. As content of a livestream video alters, the livestream analyzer module 232 computes updated values for attributes of the livestream video, and the indexer module 234 updates the livestream index 240 with the newly computed values. Therefore, the livestream index 240 reflects current values of attributes of livestream videos.

The search module 236 is configured to receive a query and search the livestream index 240 for livestream videos based upon the query. The query may be explicitly provided by the user 217 of the viewer computing device 210, where the viewer computing device 210 transmits the query to the server computing system 202. The search module 236 is provided with the query and searches the livestream index 240 for livestream videos based upon the received query. In another example, the query is an implicit query that is based upon the user profile 238 for the user 217 of the viewer computing device 210. The user profile 238 can identify preferences of the user 217 with respect to attributes of livestream videos, where the preferences can be positive (e.g., values for attributes are preferred by the user 217) or negative (e.g., values for attributes are not preferred by the user 217).

Regardless of whether the query is explicitly or implicitly provided, the query specifies values for attributes of livestream videos. The search module 236 searches the livestream index 240 and identifies a livestream video due to the computed values for the livestream video in the livestream index 240 matching (or being similar to) the values for the attributes specified in the query. Pursuant to an example, the query specifies a video game, a character, a sentiment of a streamer, and a level of the identified video game. The search module 236 searches the livestream index 240 for livestream videos that have the attribute values or similar attribute values specified in the query; in this example, the search module 236 identifies a livestream video where a streamer of the livestream video is playing the video game as the character specified in the query, where the streamer has the identified sentiment assigned thereto, and further where the streamer is playing the level of the video game specified in the query.

When the search module 236 identifies multiple livestream videos based upon the received query, the search module 236 can rank the livestream videos and form a ranked list of livestream videos. The search module 236 may employ any suitable ranking technologies when ranking livestream videos. For instance, attributes of livestream videos are assigned weights, and the search module 236 ranks livestream videos based upon the weights. Thus, in an example, when the query fails to specify a rating for a livestream video, the search module 236 ranks livestream videos based upon ratings assigned thereto, where a first rating is weighted higher than a second rating (e.g., livestream videos with a “family friendly” rating are ranked higher than livestream videos with a relatively large amount of profanity).

An example that illustrates advantages of the computing system 200 over conventional technologies for identifying livestream videos is now set forth. The first streamer 212 is livestreaming play of a video game from the first streaming computing device 204 to the server computing system 202, where the first streamer 212 is relatively popular on a livestreaming service, and the first streamer 212 is playing the video game as a first character on a first level. Simultaneously, the second streamer 214 is livestreaming play of the (same) video game from the second streaming computing device 206 to the server computing system 202, where the second streamer 214 is much less popular than the first streamer 212 on the livestreaming service, and further where the second streamer 214 is playing the video game as a second character on a second level. The livestream analyzer module 232 computes values for attributes of the first livestream video and the second livestream video, and the indexer module 234 updates the livestream index 240 to include the values for the attributes computed by the livestream analyzer module 232. Therefore, in the livestream index 240, the first livestream video is indexed by an identity of the video game, an identity of the first character, and an identifier for the first level, while the second livestream video is indexed by the identifier of video game, an identifier of the second character, and an identifier of the second level.

The user 217 of the viewer computing device 210 sets forth a query that identifies the video game, the second character, and the second level. The search module 236 searches the livestream index 240 based upon the query and identifies the second livestream video due to the values for the attributes in the query matching the values for the attributes of the second livestream video in the livestream index 240. The search module 236 can then return an identity of the second livestream video (or the second streamer 214) to the viewer computing device 210, where the user 217 can choose to begin watching the second livestream video. Conventionally, the user 217 would have no mechanism for setting forth such a granular query, but instead is limited to searching by video game title, whereupon a livestream video streamed by a most popular streamer is returned to the user 217. Therefore, conventionally, for the user 217 to identify the second livestream video (which is of interest to the user 217), the user must manually sift through several livestream videos.

While the examples set forth above have referred to a livestreaming service, it is to be understood that an aggregator service can receive livestream videos from multiple livestream services, and the livestream analyzer module 232 can receive livestream videos from multiple different livestreaming services. In such an example, the server computing system 202 can receive livestream videos from server computing systems that are receiving and broadcasting livestream videos. Thus, the livestream index 240 can index livestream videos from multiple different streaming service by values for attributes of such livestream videos.

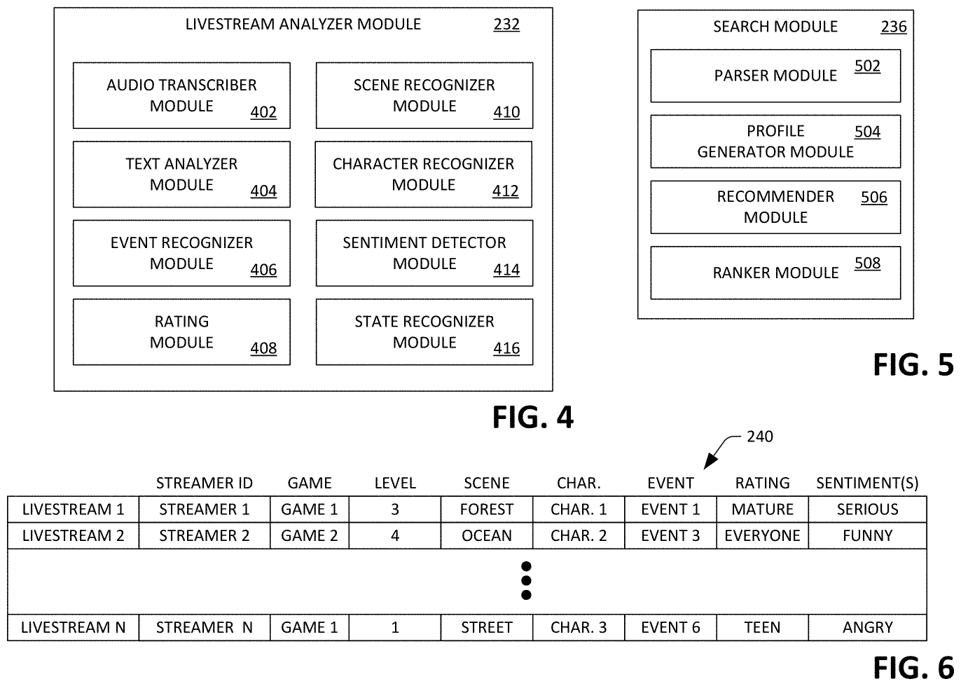

Referring now to FIG. 4, a functional block diagram of the livestream analyzer module 232 is depicted. The livestream analyzer module 232 may include several sub-modules, where one or more of the sub-modules may be a deep neural network (DNN), such as a deep convolutional neural network (DCNN), a recurrent neural network (RNN), or other suitable DNN. With more particularity, the livestream analyzer module 232 includes an audio transcriber module 402 that is configured to transcribe spoken utterances in audio of livestream videos into text. For instance, a microphone associated with the first streaming device 202 captures spoken utterances set forth by the first streamer 212, where the spoken utterances are included in the first livestream video. The audio transcriber module 402 transcribes the spoken utterances into text. In addition, a video game may include spoken utterances set forth by characters therein, by a narrator, etc. The audio transcriber module 402 is configured to transcribe such spoken utterances into text.

The livestream analyzer module 232 also includes a text analyzer module 404 that processes text output by the audio transcriber module 402 through use of natural language processing technologies. In an example, the text analyzer module 404 can identify profanities in the text output by the audio transcriber module 402, identify topics referenced in the text output by the audio transcriber module 402, identify named entities in the text output by the audio transcriber module 402, assign a value that identifies sentiment of text output by the audio transcriber module 402, etc. Pursuant to an example, the text analyzer module 404 computes values for the attributes referenced above over a time window or several time windows, such as a number of profanities in the text output by the audio transcriber module 404 over a time window, a number of times that a named entity is referenced in the text over a window of time, a number of times that a topic is referenced in the text over a window of time, etc. The text analyzer module 404 performs similar processing with respect to text in chat windows that accompany livestream videos. Therefore, the text analyzer module 404 can identify and count a number of profanities in the chat window over a window of time or several windows of time, can identify and count a number of times that a topic is referenced in the chat window over a window of time or several windows of time, etc. Other modules in the livestream analyzer module 232 are configured to receive outputs of the text analyzer module 404.

The livestream analyzer module 232 also includes an event recognizer module 406 that is configured to detect events in the livestream video being analyzed by the livestream analyzer module 232. In an example, the event recognizer module 406 can be trained for a particular video game, for a particular developer of video games, etc. Events may include, for example, the completion of a level, the defeat of a boss, a pass in an automobile racing game, achievement of a new high score, or any other suitable event that may be detected in the livestream video. The event recognizer module 406 can recognize an event based upon content in frames of the livestream video. In addition, the event recognizer module 406 can detect events in the livestream video based upon text output by the audio transcriber module 402 and/or text in the chat window that accompanies the livestream video. For instance, based solely upon image frames of the livestream video, the event recognizer module 406 determines with a first probability that an event has occurred (e.g., a boss in a video game has been defeated). The event recognizer module 406 can further receive output of the text analyzer module 404, which indicates that the boss has recently been discussed as a topic in messages in the chat window. Based upon the additional information, the event recognizer module 406 can detect occurrence of the event with a second probability that is higher than the first probability discussed above. Upon the event recognizer module 406 detecting an event in the livestream video, the livestream analyzer module 232 can output the event and the indexer module 234 can update the livestream index 240 such that the livestream video is indexed by the event in the livestream index 240.

The livestream analyzer module 232 also includes a rating module 408 that assigns a rating to the livestream video based upon, for example, output of the text analyzer module 404 and output of the event recognizer module 406. The rating assigned to the livestream video by the rating module 408 can indicate an appropriate age range for a viewer of the livestream video. Example ratings that may be assigned to the livestream video by the event recognizer module 406 can be similar to ratings assigned to films, such as “approved for general audiences” “parental guidance suggested”, “restricted for viewers under the age of 17”, etc. In an example, the rating module 408 receives sentiment of text as output by the text analyzer module 404, a number and type of profanity words as detected by the text analyzer module 404, topics identified by the text analyzer module 404, named entities identified by the text analyzer module 404, and events output by the event recognizer module 406. With respect to an event output by the event recognizer module 406, when a detected event is violent, the rating module 408 can assign a rating based upon the violence of the event. The livestream analyzer module 232 outputs the rating assigned to the livestream video, and the indexer module 234 updates the livestream index 240 such that the livestream video is indexed by the rating assigned to the livestream video.

The rating module 408 can additionally assign different ratings to a livestream video based upon observed content in the livestream video over different time windows and/or other livestream videos previously streamed by the streamer of the livestream video. For instance, historically the streamer streams family friendly livestream videos between 3:00 PM and 5:00 PM on weekdays, but later at night and on weekends the streamer streams livestream videos that include a significant amount of profanity and therefore have a more restricted rating. The rating module 408 can assign a rating to a livestream video based upon a time that the livestream video is being streamed and further based upon historic actions of the streamer and chat participants in livestream videos streamed by the streamer.

The livestream analyzer module 232 also includes a scene recognizer module 410 that is configured to recognize a scene of a video game being played in the livestream video. For instance, many video games have gameplay that occurs across several different scenes, and someone who is interested in watching a livestream video of the video game may be interested in watching play of the video game in a particular scene. The scene recognizer module 410 is configured to receive frames of the livestream video and output a value that is indicative of a scene of the video game being presented in the livestream video. Upon the livestream analyzer module 232 outputting the value for the scene, the indexer module 234 updates the livestream index 240 to include the value for the scene, such that the livestream video is indexed by the scene in the livestream index 240.

The livestream analyzer module 232 further includes a character recognizer module 412 that is configured to recognize characters captured in the livestream video. The character recognizer module 412 can identify a character being played by the streamer of the livestream video and can further recognize other characters that are depicted in the livestream video (where the other characters may be being controlled by other players of the video game or may be controlled by a computer). The livestream analyzer module 232 outputs identities of characters detected by the character recognizer module 412 and the indexer module 234 updates the livestream index 240 to include the identities of the characters, such that the livestream video is indexed in the livestream index 240 by the identified video game characters depicted in the livestream video.

The livestream analyzer module 232 further includes a sentiment detector module 414 that is configured to assign a sentiment to the livestream video based upon output of the text analyzer module 404 and/or detected features of a face of the streamer as captured in the video of the face of the streamer included in the livestream video. Example sentiments that can be assigned to the livestream video by the sentiment detector module 414 include, but are not limited to, “happy”, “sad”, “serious”, “funny”, “angry”, “mopey”, “boring”, semantic equivalents thereof, etc. In an example, the sentiment detector module 414 ascertains that the streamer is typically smiling in the livestream video and receives output of the text analyzer module 404 that indicates that spoken utterances of the streamer are typically positive and messages in the chat window are typically positive. Hence, the sentiment detector module 414 assigns the sentiment “happy” to the livestream video. In another example, the sentiment detector modules 414 assigns the sentiment based upon tone of spoken utterances set forth by the streamer, where the livestream video captures the spoken utterances. It is to be understood that the sentiment detector module 414 can employ any suitable technologies for assigning a sentiment to the livestream video. Upon the sentiment detector module 414 assigning the sentiment to the livestream video, the livestream analyzer module 232 outputs the sentiment, and the indexer module 234 updates the livestream index 240 to include the sentiment. Therefore, the livestream video is indexed in the computer-readable index 240 by the sentiment.

The livestream analyzer module 232 further includes a state recognizer module 416 that is configured to identify a state of a video game represented in the livestream video, where the state recognizer module 416 identifies the state based upon content of the livestream video. The state of the video game may be a level of the video game that is currently being played, a racetrack where the streamer is racing a car in the video game, a boss that is currently being battled by the streamer in the video game, etc. Therefore, the state recognizer module 416 can assign values for multiple different possible states of the video game that is being livestreamed, and the livestream analyzer module 232 can output the values that identify such states. The indexer module 234 updates the livestream index 240 to include the values for these states, such that the livestream video is indexed by the values of the states in the livestream index 240.

It can be ascertained that one or more of the modules 402-416 may be specific to a particular video game. Further, it is to be understood that the modules 402-416 update values as content of the livestream video and/or content of text in the chat window alters. Therefore, as mentioned above, the livestream index 240 is a “real-time” index that reflects current content of the livestream video and/or associated chat window. Further, it is to be understood that the server computing system 202 has multiple instances of the livestream analyzer module executing thereon, such that multiple livestream videos are subject to analysis simultaneously.

With reference now to FIG. 5, a functional block diagram of the search module 236 is illustrated. The search module 236 optionally includes a parser module 502, where the parser module 502 is configured to parse text in natural language queries set forth by users who are searching for livestream videos to view. The parser module 502 can identify or compute values for attributes of livestream videos based upon text in a natural language query received by the search module 236, and the search module 236 can search the computer-readable index 240 based upon the values of the attributes. The parser module 502 can employ any suitable natural language processing technologies in connection with identifying or computing values for attributes of livestream videos based upon content of a query.

The search module 236 also optionally includes a profile generator module 504 that is configured to construct a profile for the user 217 based upon historic interactions of the user 217 with livestream videos streamed by way of the server computing system 202. As indicated above, the user 217 may set forth explicit feedback with respect to livestream videos and/or streamers who stream the livestream videos. Such feedback may be a star rating, a thumbs up, a thumbs down, and so forth. In addition, the profile generator module 504 can monitor length of time that the user 217 views livestream videos and can infer preferences of the user 217 with respect to values of attributes of livestream videos. In a non-limiting example, the user 217 spends a significant amount of time watching livestream videos where streamers play a video game as a certain character. The profile generator module 504 can infer that the user 217 prefers to watch livestream videos where the streamers are playing as the particular character and can update the user profile 238 to include an identity of the character. In another example, the profile generator module 504 can ascertain, based upon observed viewing habits of the user 217, that the user 217 spends a relatively large amount of time watching livestream videos that have the sentiment “funny” assigned thereto. The profile generator module 504 can generate/update the user profile 238 to indicate that the user 217 prefers to watch livestream videos that are assigned the sentiment “funny”. Further, the profile generator module 504 can identify values for attributes that the user does not prefer (dislikes) based upon observed interactions of the user with livestream videos and/or streamers. For instance, the user 217 sets forth feedback that indicates that the user 217 dislikes livestream videos that include a relatively large amount of profanity in the chat windows associated with the livestream videos. The profile generator module 504 can generate/update the user profile 238 to indicate that the user dislikes livestream videos with chats having a relatively large number of profane words therein.

The search module 236 further optionally includes a recommender module 506 that outputs recommended livestream videos for the user 217 to watch based upon the user profile 238 generated and updated by the profile generator module 504. For instance, the recommender module 506 can construct a query based upon values for attributes identified in the user profile 238. The search module 236 searches the computer-readable index 240 based upon the query constructed by the recommender module 506 and identifies several livestream videos that have attribute values that match or partially match the attribute values in the constructed query. Hence, the recommender module 506 is able to recommend livestream videos to the user 217 based upon current content of the livestream videos and the user profile 238.

The search module 236 also includes a ranker module 508 that is configured to rank livestream videos identified by the search module 236, where the ranker module 508 ranks the livestream videos based upon attribute values of the livestream videos. The ranker module 508 can be learned as conventional rankers are learned; by minimizing output of a loss function during a training phase. The ranker module 508 may be trained such that livestream videos having a first sentiment assigned thereto are ranked more highly than livestream videos having a second sentiment assigned thereto; in another example, the ranker module 508 is trained such that a first livestream video where a first character is being played by a first streamer is ranked higher than a second livestream video where a second character is being played by a second streamer. Other examples will be readily contemplated.

Referring briefly to FIG. 6, a depiction of the livestream index 240 is presented. In the livestream index 240 illustrated in FIG. 6, livestream videos are indexed by values for the following attributes: Streamer ID; Game ID; Game Level; Game Scene; Game Character; Game Event; Livestream Rating; and Livestream Sentiment. Therefore, when a query set forth by the user 217 specifies the Game ID “Game 1” and the Game Character “Character 1”, an identity of the first livestream video is returned to the user based upon the query.

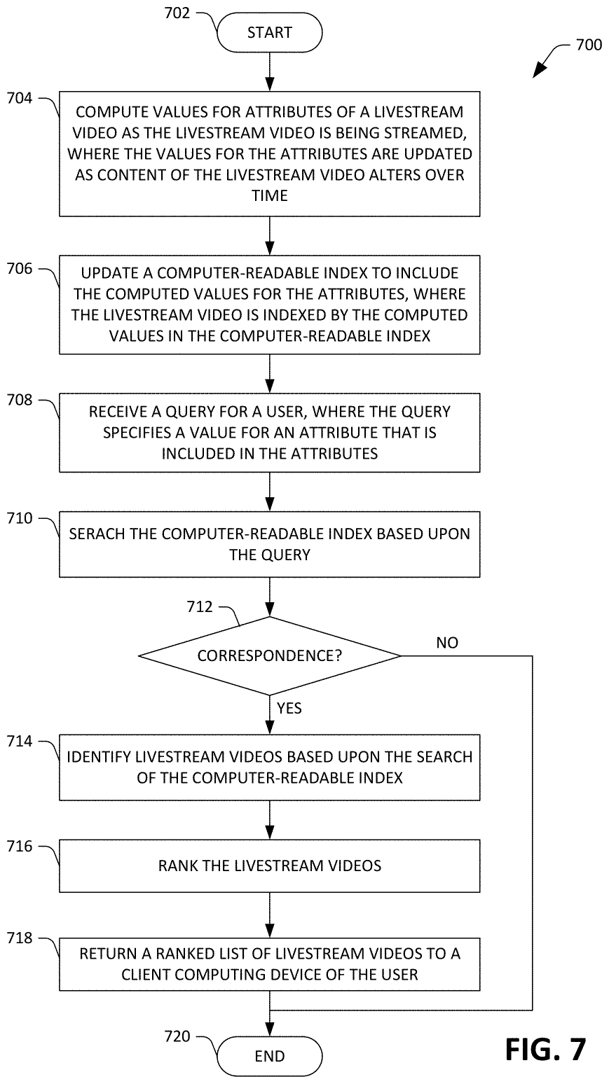

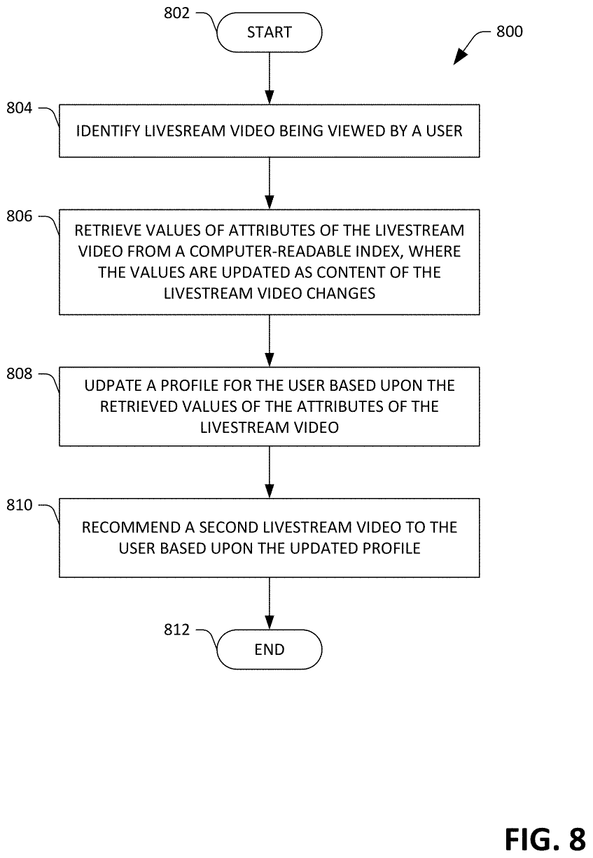

FIGS. 7 and 8 illustrate methodologies relating to identifying livestream videos based upon a query that specifies real-time attribute values of the livestream videos. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Now referring solely to FIG. 7, a flow diagram illustrating a methodology 700 for identifying a livestream video to present to a viewer is depicted. The methodology 700 starts at 702, and at 704 values are computed for attributes of a livestream video as the livestream video is being streamed from a streaming computing device to a server computing system. The values of the attributes are updated as content of the livestream video alters over time.

At 706, upon the values for the attributes being computed, a computer-readable index is updated to include the computed values for the attributes. Thus, in the computer-readable index, the livestream video is indexed by the computed values.

At 708, a query is received from a client computing device of the viewer, where the query specifies a value for an attribute that is included in the attributes of the livestream video. At 710, the computer-readable index is searched based upon the query. At 712, a determination is made as to whether the value for the attribute specified in the query corresponds to the value for the attribute in the computer-readable index (e.g., whether the value for the attribute specified in the query matches or partially matches the value for the attribute in the computer-readable index). When it is determined at 712 that the value for the attribute specified in the query corresponds to the value for the attribute in the computer-readable index, the methodology 700 proceeds to 714, where the livestream video is identified based upon the searching of the computer-readable index. With more particularity, the livestream video is identified based upon the value for the attribute specified in the query corresponding to the value for the attribute in the computer-readable index.

At 716, livestream videos identified based upon the query are ranked, and at 718 a ranked list of livestream videos is returned to the client computing device, where an identifier for the livestream video is included in the ranked list of livestream videos. In an example, a thumbnail of the livestream video may be included in the ranked list of livestream videos, where upon a user hovering over the thumbnail, the livestream video is played in the thumbnail. When it is determined at 712 that no correlation exists, or subsequent to the ranked list of livestream videos being returned to the client computing device of the viewer, the methodology 700 completes at 720.

Referring now to FIG. 8, a methodology 800 for recommending a livestream video to a user is illustrated. The methodology 800 starts at 802, and at 804 a livestream video being viewed by the user is identified. At 806 values of attributes of the livestream video being viewed by the user are retrieved from a computer-readable index. As discussed above, values of attributes for the livestream video are updated as content of the livestream video alters over time; therefore, when the values of the attributes are retrieved, the values are representative of current content of the livestream video.

At 808, a profile for the user is updated based upon the retrieved values of the attributes of the livestream video. For instance, the profile of the user can be updated to indicate that the user prefers to watch livestream videos that have a particular value for an attribute of the livestream videos. At 810, a second livestream video is recommended to the user based upon the updated profile. For instance, the second livestream video can have the value for the attribute that is identified as being preferred in the profile for the user. The methodology 800 completes at 812.

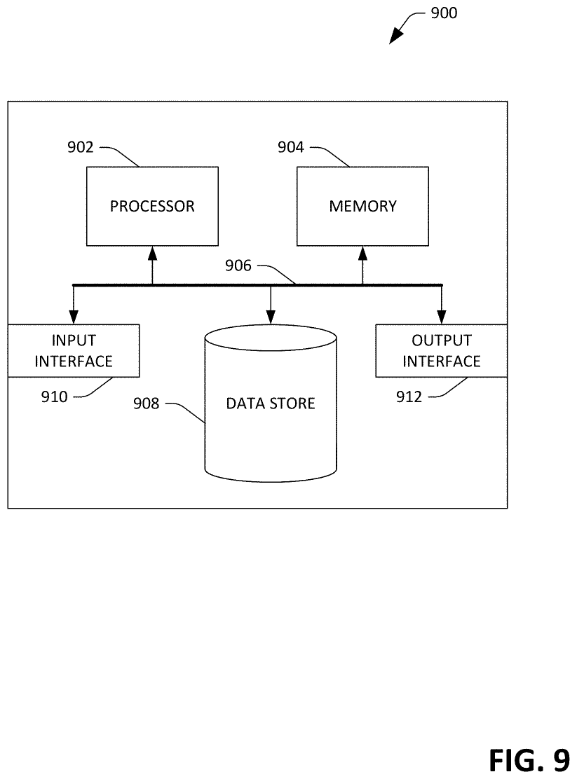

Referring now to FIG. 9, a high-level illustration of an exemplary computing device 900 that can be used in accordance with the systems and methodologies disclosed herein is illustrated. For instance, the computing device 900 may be used in a system that streams a livestream video from a client computing device to a streaming server. By way of another example, the computing device 900 can be used in a system that is configured to support searching for livestream videos based upon attributes computed for the livestream videos. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store at least a portion of a computer-readable index, a profile of a user, etc.

The computing device 900 additionally includes a data store 908 that is accessible by the processor 902 by way of the system bus 906. The data store 908 may include executable instructions, a computer-readable index, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

The features described herein relate to allowing for livestream videos to be searched for based upon attributes that reflect current content of the livestream videos according to at least the examples provided below.

(A1) In one aspect, some embodiments include a computer-implemented method, where the method includes performing (710) a search over a computer-readable index (240) based upon a query from a user (217). The computer-readable index (240) includes: a) an identifier for a livestream video that is currently being livestreamed by way of a livestreaming service; and 2) values for respective attributes of the livestream video, where the values for the respective attributes are automatically updated as content of the livestream video alters over time. The query specifies one or values of one or more of the attributes of the livestream video. The method also includes identifying (714) the livestream video from amongst a plurality of livestream videos being livestreamed by way of the livestreaming service based upon the search, wherein the livestream video is identified based on a value of the one or more attribute values corresponding to the values for the respective attributes in the computer-readable index (240). The method additionally includes transmitting (718) an identifier of the livestream video to a client computing device (210) of the user (217) upon the livestream video being identified.

(A2) In some embodiments of the method of A1, the livestream video includes a window (304) that comprises a video of a face of a streamer of the livestream video. Further, the method further includes, prior to performing the search, computing a sentiment for the livestream video based upon the video of the face of the streamer included in the window. The method additionally includes, prior to performing the search, updating the computer-readable index (240) to include a value that identifies the sentiment computed for the livestream video. The value is specified in the query, and the livestream video is identified based on the value specified in the query corresponding to the value included in the computer-readable index (240).

(A3) In some embodiments of any of the methods of A1-A2, a chat window (316) accompanies the livestream video and is presented to viewers of the livestream video, where the chat window includes messages set forth by multiple viewers of the livestream video. The method additionally includes, prior to performing the search, and based upon content of the messages, assigning a rating to the livestream video, where the rating is indicative of a recommended age of a viewer of the livestream video. The method also includes, prior to performing the search, updating the computer-readable index (240) to include the rating, where the rating is specified in the query, and further where the livestream video is identified based on the rating specified in the query corresponding to the rating included in the computer-readable index (240).

(A4) In some embodiments of any of the methods of A1-A3, the livestream video comprises video (305) of a video game being played by a streamer of the livestream video. The method also includes, prior to performing the search, detecting an event in the video of the video game. The method further includes, prior to performing the search, updating the computer-readable index (240) to include a value that is indicative of the event, where the value is specified in the query, and further where the video is identified based upon the value specified in the query corresponding to the value included in the computer-readable index (240).

(A5) In some embodiments of any of the methods of A1-A4, the livestream video includes video (305) of a video game being played by a streamer of the livestream video. The method also includes, prior to performing the search, detecting a character (306) in the video of the video game. The method further includes, prior to performing the search, updating the computer-readable index (240) to include a value that indicates that the video of the video game currently includes the character, where the value is specified in the query, and further where the livestream video is identified based upon the value specified in the query corresponding to the value included in the computer-readable index (240).

(A6) In some embodiments of any of the methods of A1-A5, the livestream video includes video (305) of a video game being played by a streamer of the livestream video, and the method also includes, prior to performing the search, detecting a level being played in the video game based upon the video of the video game. The method also includes, prior to performing the search, updating the computer-readable index (240) to include a value that is indicative of the level being played in the video game, where the value is specified in the query, and further where the livestream video is identified based upon the value specified in the query corresponding to the value included in the computer-readable index (240).

(A7) In some embodiments of any of the methods of A1-A6, the livestream video includes video (305) of a video game being played by a streamer of the livestream video, and the method also includes, prior to performing the search, identifying status of the video game based upon text in the video of the video game. The method also includes, prior to performing the search, updating the computer-readable index (240) to include a value that is indicative of the status of the video game, where the value is specified in the query, and further where the livestream video is identified based upon the value specified in the query corresponding to the value included in the computer-readable index (240).

(A8) In some embodiments of any of the methods of A1-A7, the livestream video comprises audio that includes spoken utterances set forth by a streamer of the livestream video, and the method also includes, prior to performing the search, transcribing the spoken utterances set forth by the streamer in the audio to form computer-readable text. The method additionally includes, prior to performing the search, updating a value of an attribute in the attributes based upon the computer-readable text, where the value is specified in the query, and further where the livestream video is identified based upon the value specified in the query corresponding to the value included in the computer-readable index (240).

(A9) In some embodiments of any of the methods of A1-A8, the method also includes, prior to performing the search, causing a graphical user interface (100) to be presented on a display of the client computing device (210) of the user (217), the graphical user interface (100) comprising interactive graphical elements (102-112) that are configured to receive the one or more values from the user (217) of the client computing device (210), where the query is formed based upon the one or more values received from the user by way of the graphical user interface.

(A10) In some embodiments of any of the methods of A1-A9, the method also includes constructing the query based upon values of attributes of livestream videos previously viewed by the user.

(A11) In some embodiments of any of the methods of A1-A10, the method also includes, prior to performing the search, detecting that the user (217) is viewing a second livestream video that is streaming by way of the livestreaming service. The method also includes, prior to performing the search, updating a profile for the user (217) based upon values of attributes of the second livestream video. The method additionally includes, prior to performing the search, constructing the query based upon the profile for the user.

(B1) In another aspect, some embodiments include a method (700) for identifying a livestream video to present to a viewer. The method includes, as the livestream video is streaming by way of a streaming service, computing (704) values for respective attributes of the livestream video, where the values of the respective attributes are updated as the livestream video continues to be streamed by way of the streaming service. The method also includes, upon computing the values for the respective attributes, (706) updating a computer-readable index (240) to include the computed values for the respective attributes, where the livestream video is indexed by the computed values in the computer-readable index (240). The method further includes receiving (708) a query from a client computing device (210) of the viewer (217), where the query specifies a value for an attribute that is included within the respective attributes. The method additionally includes searching the computer-readable index (240) based upon the query, as well as identifying the livestream video based upon the searching of the computer-readable index (240), where the livestream video is identified based upon the value for the attribute specified in the query corresponding to the value for the attribute in the computer-readable index (240). The method further includes returning a ranked list of livestream videos to the client computing device (210), where an identifier for the livestream video is included in the ranked list of livestream videos.

(B2) In some embodiments of the method of B1, the attributes have weights assigned thereto, and the method also includes ranking several livestream videos being streamed by way of the streaming service based upon the weights assigned to the attributes.

(B3) In some embodiments of any of the methods of B1-B2, the ranked list of livestream videos includes a thumbnail of the livestream video that, when hovered over, plays on the client computing device.

(B4) In some embodiments of any of the methods of B1-B3, the livestream video includes video (305) of a video game being played by a streamer of the livestream video, and a value in the values identifies a character being used by the streamer when playing the video game.

(B5) In some embodiments of any of the methods of B1-B4, the livestream video includes video (305) of a video game being played by a streamer of the video game, and a value in the values identifies an event that has occurred in the video game being played by the streamer.

(B6) In some embodiments of any of the methods of B1-B5, the livestream video includes audio, and the method further includes computing a value that is indicative of sentiment of the livestream video based upon the audio, where the value is included in the values.

(B7) In some embodiments of the method of B6, the audio includes spoken utterances set forth by a streamer of the livestream video, and the method also includes generating transcriptions of the spoken utterances in the audio, where the value is computed based upon the transcriptions of the spoken utterances.

(B8) In some embodiments of any of the methods of B1-B7, a chat window (316) accompanies the livestream video, and the chat window (316) includes text set forth by viewers of the livestream video. The method also includes computing a rating for the livestream video based upon the text in the chat window that accompanies the livestream video, the rating indicative of an appropriate age for viewing the livestream video, wherein the rating is included in the values.

(C1) In yet another aspect, some embodiments include a method for identifying a livestream video to present to a viewer, where the method includes performing a search (710) over a computer-readable index (240) based upon a query for a user (217), where the computer-readable index includes: a) an identifier for a livestream video (302) that is currently being livestreamed by way of a livestreaming service; and b) values for respective attributes of the livestream video (302), wherein the values for the respective attributes are updated as content of the livestream video (302) being livestreamed alters over time. The query specifies a set of values for a respective set of attributes in the attributes. The method also includes identifying (714) the livestream video (302) from amongst several livestream videos being livestreamed by way of the livestreaming service based upon the search, where the livestream video (302) is identified due to the set of values specified in the query corresponding to the values for the respective attributes in the computer-readable index (240). The method also includes, upon the livestream video being identified, transmitting (718) an identifier of the livestream video (302) to a client computing device (210) of the user (217).

(D1) In still yet another aspect, some embodiments include a computing system that includes a processor and memory, where the memory has instructions stored therein that, when executed by the processor, cause the processor to perform any of the methods described herein (e.g., any of A1-A11, B1-B8, and/or C1).

(E1) In another aspect, some embodiments include a computer-readable storage medium that includes instructions that, when executed by a processor, cause the processor to perform any of the methods described herein (e.g., any of A1-A11, B1-B8, and/or C1).

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component,” “system,” and “module” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
performing a search over a computer-readable index based upon a query from a user, the computer-readable index comprises:
an identifier for a livestream video that is currently being livestreamed by way of a livestreaming service;
values for respective attributes of the livestream video, wherein the values for the respective attributes are automatically updated as content of the livestream video alters over time;
wherein the query specifies one or values of one or more of the attributes of the livestream video;
identifying the livestream video from amongst a plurality of livestream videos being livestreamed by way of the livestreaming service based upon the search, wherein the livestream video is identified based on a value of the one or more attribute values corresponding to the values for the respective attributes in the computer-readable index; and
upon the livestream video being identified, transmitting an identifier of the livestream video to a client computing device of the user.

2. The computing system of claim 1, wherein the livestream video includes a window that comprises a video of a face of a streamer of the livestream video, the acts further comprising:
prior to performing the search:
computing a sentiment for the livestream video based upon the video of the face of the streamer included in the window; and
updating the computer-readable index to include a value that identifies the sentiment computed for the livestream video, wherein the value is specified in the query, and further wherein the livestream video is identified based on the value specified in the query corresponding to the value included in the computer-readable index.

3. The computing system of claim 1, wherein a chat window accompanies the livestream video and is presented to viewers of the livestream video, the chat window comprises messages set forth by multiple viewers of the livestream video, the acts further comprising:
prior to performing the search:
based upon content of the messages, assigning a rating to the livestream video, wherein the rating is indicative of a recommended age of a viewer of the livestream video; and
updating the computer-readable index to include the rating, wherein the rating is specified in the query, and further wherein the livestream video is identified based on the rating specified in the query corresponding to the rating included in the computer-readable index.

4. The computing system of claim 1, wherein the livestream video comprises video of a video game being played by a streamer of the livestream video, the acts further comprising:
prior to performing the search:
detecting an event in the video of the video game; and
updating the computer-readable index to include a value that is indicative of the event, wherein the value is specified in the query, and further wherein the video is identified based upon the value specified in the query corresponding to the value included in the computer-readable index.

5. The computing system of claim 1, wherein the livestream video comprises video of a video game being played by a streamer of the livestream video, the acts further comprising:
prior to performing the search
detecting a character in the video of the video game; and
updating the computer-readable index to include a value that indicates that the video of the video game currently includes the character, wherein the value is specified in the query, and further wherein the livestream video is identified based on the value specified in the query corresponding to the value included in the computer-readable index.

6. The computing system of claim 1, wherein the livestream video comprises video of a video game being played by a streamer of the livestream video, the acts further comprising:
prior to performing the search:
detecting a level being played in the video game based upon the video of the video game; and
updating the computer-readable index to include a value that is indicative of the level being played in the video game, wherein the value is specified in the query, and further wherein the livestream video is identified based on the value specified in the query corresponding to the value included in the computer-readable index.

7. The computing system of claim 1, wherein the livestream video comprises video of a video game being played by a streamer of the livestream video, the acts further comprising:
prior to performing the search:
identifying status of the video game based upon text in the video of the video game; and
updating the computer-readable index to include a value that is indicative of the status of the video game, wherein the value is specified in the query, and further wherein the livestream video is identified based on the value specified in the query corresponding to the value included in the computer-readable index.

8. The computing system of claim 1, wherein the livestream video comprises audio that includes spoken utterances set forth by a streamer of the livestream video, the acts further comprising:
prior to performing the search:
transcribing the spoken utterances set forth by the streamer in the audio to form computer-readable text; and
updating a value of an attribute in the attributes based upon the computer-readable text, wherein the value is specified in the query, and further wherein the livestream video is identified based on the value specified in the query corresponding to the value included in the computer-readable index.

9. The computing system of claim 1, the acts further comprising:
prior to performing the search:
causing a graphical user interface to be presented on a display of the client computing device of the user, the graphical user interface comprising interactive graphical elements that are configured to receive the values for the respective set of attributes from the user of the client computing device, wherein the query is formed based upon the values received from the user by way of the graphical user interface.

10. The computing system of claim 1, the acts further comprising constructing the query based upon values of attributes of livestream videos previously viewed by the user.

11. The computing system of claim 1, the acts further comprising:
prior to performing the search:
detecting that the user is viewing a second livestream video that is streaming by way of the livestreaming service;
updating a profile for the user based upon values of attributes of the second livestream video; and
constructing the query based upon the profile for the user.

12. A method for identifying a livestream video to present to a viewer, the method comprising:
as the livestream video is streaming by way of a streaming service, computing values for respective attributes of the livestream video, wherein the values of the respective attributes are updated as the livestream video continues to be streamed by way of the streaming service;
upon computing the values for the respective attributes, updating a computer-readable index to include the computed values for the respective attributes, wherein the livestream video is indexed by the computed values in the computer-readable index;
receiving a query from a client computing device of the viewer, wherein the query specifies a value for an attribute that is included within the respective attributes;
searching the computer-readable index based upon the query;
identifying the livestream video based upon the searching of the computer-readable index, wherein the livestream video is identified based upon the value for the attribute specified in the query corresponding to the value for the attribute in the computer-readable index; and
returning a ranked list of livestream videos to the client computing device, wherein an identifier for the livestream video is included in the ranked list of livestream videos.

13. The method of claim 12, wherein the attributes have weights assigned thereto, the method further comprising ranking several livestream videos being streamed by way of the streaming service based upon the weights assigned to the attributes.

14. The method of claim 12, wherein the ranked list of livestream videos includes a thumbnail of the livestream video that, when hovered over, plays on the client computing device.

15. The method of claim 12, wherein the livestream video includes video of a video game being played by a streamer of the livestream video, and further wherein a value in the values identifies a character being used by the streamer when playing the video game.

16. The method of claim 12, wherein the livestream video includes a video of a video game being played by a streamer of the video game, and further wherein a value in the values identifies an event that has occurred in the video game being played by the streamer.

17. The method of claim 12, wherein the livestream video includes audio, the method further comprising:
computing a value that is indicative of sentiment of the livestream video based upon the audio, wherein the value is included in the values.

18. The method of claim 17, wherein the audio includes spoken utterances set forth by a streamer of the livestream video, the method further comprising:
generating transcriptions of the spoken utterances in the audio, wherein the value is computed based upon the transcriptions of the spoken utterances.

19. The method of claim 12, wherein a chat window accompanies the livestream video, and further wherein the chat window comprises text set forth by viewers of the livestream video, the method further comprising:
computing a rating for the livestream video based upon the text in the chat window that accompanies the livestream video, the rating indicative of an appropriate age for viewing the livestream video, wherein the rating is included in the values.

20. A computer-readable storage medium comprising instructions that, when executed by a processor, cause the processor to perform acts comprising:
performing a search over a computer-readable index based upon a query for a user, the computer-readable index comprises:
an identifier for a livestream video that is currently being livestreamed by way of a livestreaming service;
values for respective attributes of the livestream video, wherein the values for the respective attributes are updated as content of the livestream video being livestreamed alters over time;
wherein the query specifies a set of values for a respective set of attributes in the attributes;
identifying the livestream video from amongst several livestream videos being live-streamed by way of the livestreaming service based upon the search, wherein the video is identified due to the set of values specified in the query corresponding to the values for the respective attributes in the computer-readable index; and
upon the livestream video being identified, transmitting an identifier of the livestream video to a client computing device of the user.
